(19) United States
(12) Patent Application Publication
(10) Pub. No.: US 2021/0069884 A1
(43) Pub. Date: Mar. 11, 2021

(54) HANDHELD MACHINE TOOL HAVING A GEARBOX FLANGE

(71) Applicant: Robert Bosch GmbH, Stuttgarty (DE)

(72) Inventors: Christian Lang, Stuttgart (DE); Simon Erbele, Nufringen (DE)

(21) Appl. No.: 17/009,967

(22) Filed: Sep. 2, 2020

(30) Foreign Application Priority Data
Sep. 11, 2019 (DE) 102019213795.4
Jul. 3, 2020 (DE) 102020208347.9

(51) Int. Cl. B25D 11/06

(52) U.S. Cl. CPC B25D 11/06; B25D 2250/095; B25D 2211/06

(57) ABSTRACT

In a handheld machine tool having a tool holder and a housing in which at least one gear unit as well as an electronically commutatable drive motor having a stator and a rotor for driving an insertion tool able to be placed in the tool holder are situated, a drive-side gearbox flange, which at least regionally seals the gear unit, is allocated to the gear unit. The drive-side gearbox flange has, on its end face facing the stator, an accommodation region for the at least regional accommodation of at least one motor component allocated to the stator.

### CROSS REFERENCE

The present application claims the benefit under 35 U.S.C. § 119 of German Patent Application No. DE 102019213795.4 filed on Sep. 11, 2019, and German Patent Application No. DE 102020208347.9 filed on Jul. 3, 2020, which are both expressly incorporated herein by reference in their entireties.

### FIELD

The present invention relates to a handheld machine tool having a tool holder and a housing, in which at least one gear unit as well as one electrically commutated drive motor having a stator and a rotor are situated for driving an insertable tool able to be placed in the tool holder, a drive-side gearbox flange, which at least regionally seals the gear unit, being allocated to the gear unit.

### BACKGROUND INFORMATION

A conventional handheld machine tool may have a housing in which a gear unit and an electrically commutated drive motor are situated. In such a tool, a drive-side gearbox flange, which seals the gear unit, is allocated to the gear unit. The gearbox flange is situated at a distance from the drive motor in the axial direction of the gear unit.

### SUMMARY

The present invention relates to a handheld machine tool. In accordance with an example embodiment, the handheld machine tool has a tool holder and a housing in which at least one gear unit as well as an electronically commutated drive motor including a stator and a rotor for driving an insertion tool able to be placed in the tool holder are situated, and a drive-side gearbox flange, which at least sectionally seals the gear unit, is allocated to the gear unit. In accordance with an example embodiment of the present invention, the drive-side gearbox flange has on its end face facing the stator an accommodation region for the at least regional accommodation of at least one motor component allocated to the stator.

The present invention thus makes it possible to provide a handheld machine tool that allows for a short and compact design of the handheld machine tool due to the accommodation region. In particular, better support of a drive shaft allocated to the drive motor is thus able to be achieved in a simple and uncomplicated manner.

In the context of the present invention, the term ‘motor component’ is understood as a component which is allocated to the drive unit, in particular to the drive motor, and attached to the drive motor, in particular, so that, for instance, a motor shaft of the drive motor is not to be understood as a motor component in the context of the present invention. The motor component is disposed between the drive motor and the gear unit, in particular a gearbox flange. The at least one motor component may be developed as a mechanical motor component, e.g., as an anti-rotation web of the drive motor, in particular of the stator of the drive motor; as an electromechanical motor component, exemplarily developed as a motor terminal; and/or as an electrical motor component such as an electronics board, i.e. a circuit board fitted with electronic components.

The accommodation region preferably has at least one accommodation element in the circumferential direction of the drive-side gearbox flange for the accommodation of the at least one motor component. Thus, a compact drive unit, and consequently a compact handheld machine tool, are able to be provided in a simple manner.

Webs are preferably provided, which are developed to form the at least one accommodation element allocated to the accommodation region. A robust and stable accommodation region is consequently able to be formed.

According to one example embodiment, the at least one accommodation element allocated to the accommodation region is developed as a recess. As a result, the accommodation region is able to have a simple and reliable design.

The at least one accommodation element is preferably developed to at least regionally accommodate the at least one motor component allocated to the stator, preferably to accommodate motor terminals. As a result, the compact design of the handheld machine tool is easily able to be achieved by a nested arrangement of the stator and the gearbox flange. The term ‘motor terminal’ in the context of the present invention is to be understood as a connection element for connecting a motor winding of the drive motor. The motor terminals are preferably developed as wire elements, which are connected to one another via a connection unit such as a connection plate.

The at least one accommodation element is preferably developed in such a way that the at least one motor component projects beyond bearing elements for supporting the drive-side gearbox flange in the longitudinal direction of the drive unit or the drive motor. A secure and robust support is thereby able to be achieved.

The drive-side gearbox flange preferably has on its first axial end a first bearing region for the positioning of a first bearing element, and it has a second bearing region, which is set apart from the first bearing region, for the positioning of a second bearing element. This makes it possible to provide simple and reliable mounting.

According to one example embodiment, the bearing region has a first outer diameter and the second bearing region has a second outer diameter, which is greater than the first outer diameter. It is therefore possible to place a bearing region in the area of the accommodation region so that a relatively short gearbox flange is able to be provided.

The gearbox flange preferably has an interior space for the positioning of the gear unit, and an output-side end face of the accommodation region of the gearbox flange has receptacles, the ring gear of the gear unit being regionally situated in the receptacles in order to form an anti-rotation lock. An anti-rotation lock for the ring gear in the gearbox flange is therefore able to be provided in an uncomplicated manner.

The hand-held machine tool is preferably developed as a rotary hammer drill having a percussive tool, the percussive tool being allocated to the gear unit. At least sections of the percussive tool may thus be positioned in the gearbox flange in an uncomplicated manner.

According to one development of the present invention, the at least one motor component is a circuit board, which is allocated to the drive motor and fitted with electronic components. The compact design of the handheld machine tool is thus realizable by a nested arrangement of the drive motor and the circuit board.

According to one example embodiment of the present invention, the at least one motor component is an anti-rotation web, which is allocated to the drive motor and developed in the longitudinal direction of the drive motor. A nested arrangement of the drive motor and the anti-rotation web is therefore easy to realize, the anti-rotation web making it possible to prevent twisting of the stator during the operation of the drive motor, thereby providing a simple and uncomplicated anti-rotation lock.

The gearbox flange preferably has a recess, which is allocated to the at least one anti-rotation web in order to allow the at least one anti-rotation web to penetrate the gearbox flange. In this way, a compact positioning of the motor component and the gearbox flange is achievable, the anti-lock web being used to form an anti-rotation lock of the stator of the drive motor.

### BRIEF DESCRIPTION OF THE DRAWINGS

The present invention will be discussed in greater detail in the following description on the basis of exemplary embodiments shown in the figures.

FIG. 1 shows a side view of a handheld machine tool according to an example embodiment of the present invention.

FIG. 2 shows a partial longitudinal section through the handheld machine tool of FIG. 1 in order to illustrate a gearbox flange of the handheld machine tool.

FIG. 3 shows a partial longitudinal section through the handheld machine tool of FIG. 1 in order to illustrate a further gearbox flange of the handheld machine tool.

FIG. 4 shows a perspective top view of the gearbox flange of FIG. 2.

FIG. 5 shows a perspective top view of the gearbox flange of FIG. 3.

FIG. 6 shows a perspective top view of the gearbox flange of FIGS. 3 and 5 viewed from the direction of an output side.

FIG. 7 shows a top view of the gearbox flange of FIG. 5 and FIG. 6 viewed from the direction of the output side.

FIG. 8 shows a side view of the gearbox flange of FIG. 5 through FIG. 7 and the drive motor allocated to the handheld machine tool.

FIG. 9 shows a side view of the gearbox flange of FIGS. 5 through 7 and the drive motor, including a circuit board, allocated to the handheld machine tool.

FIG. 10 shows a perspective top view of the gearbox flange, the drive motor as well as the circuit board of FIG. 9.

FIG. 11 shows a longitudinal section through the gearbox flange, the drive motor as well as the circuit board of FIG. 9 and FIG. 10.

FIG. 12 shows a perspective top view of the gearbox flange of FIGS. 5 through 11, the drive motor as well as an anti-rotation web allocated to the drive motor.

FIG. 13 shows a partial longitudinal section of the gearbox flange, the drive motor as well as the anti-rotation web of FIG. 12.

FIG. 14 shows a top view of an alternative gearbox flange having the anti-rotation web of FIG. 12 and FIG. 13.

### DETAILED DESCRIPTION OF EXAMPLE EMBODIMENTS

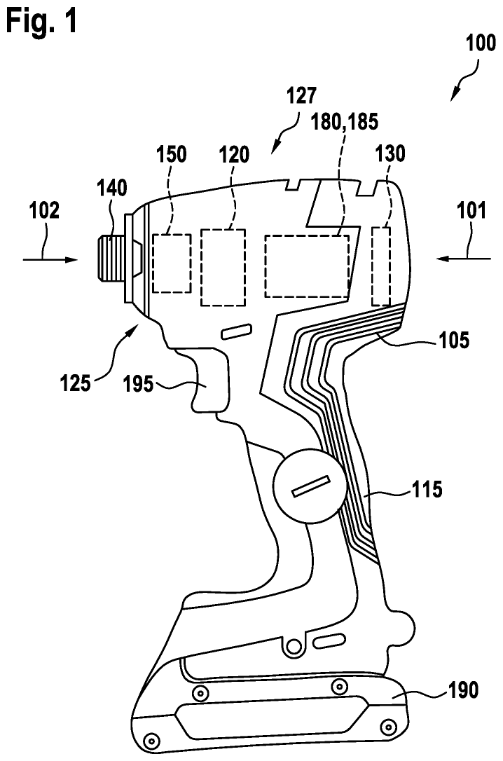

FIG. 1 shows an exemplary handheld machine tool 100, which has a housing 105 provided with a handle 115. According to one example embodiment, handheld machine tool 100 is able to be mechanically and electrically connected to a battery pack 190 for a network-independent current supply, but it may alternatively also be operated in a network-dependent manner, for example.

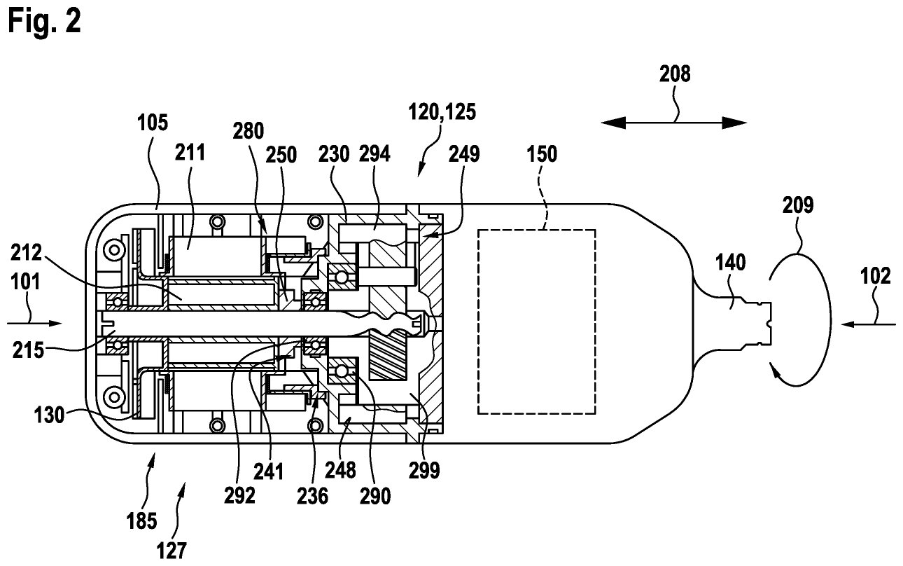

Preferably situated inside housing 105 is a drive unit 127, which has a first axial end 101 and an opposite second axial end 102. The two axial ends 101, 102 define an axial direction of drive unit 127, which extends in parallel with a longitudinal extension or a longitudinal direction (208 in FIG. 2) of drive unit 127. Drive unit 127 has at least one gear unit 125 as well as an electric drive motor 180, which is preferably supplied with current by battery pack 190. Gear unit 125 is preferably situated facing second axial end 102, and drive motor 180 is situated facing first axial end 101. Preferably, at least one gearing 120 is allocated to gear unit 125.

By way of example, handheld machine tool 100 is developed as a rotary hammer drill equipped with a percussive tool 150. Percussive tool 150 is allocated to gear unit 125. However, it is pointed out that the present invention is not restricted to rotary hammer drills but may generally be used in different handheld machine tools, with or without percussive tool 150, which have a drive motor and a gear unit, e.g., in battery-powered screw drillers.

Drive motor 180 is able to be switched on and off with the aid of a manual switch 195, for example. Drive motor 180 is preferably implemented as an electronically commutated motor 185.

A tool holder 140 for accommodating an insertion tool such as a screw bit is allocated to handheld machine tool 100 at second axial end 102. Drive motor 180 is preferably developed to drive tool holder 140 and thus the insertion tool.

In addition, a fan 130 is preferably provided. For illustration purposes and by way of example, fan 130 is disposed at first axial end 101, but it may also be placed in any other location in housing 105.

However, handheld machine tool 100 may also be developed without fan 130.

FIG. 2 shows drive unit 127 of FIG. 1 and illustrates the positioning of fan 130, drive motor 180 and 185 as well as gear unit 125. As described in FIG. 1, drive motor 180 is preferably developed as an electronically commutated drive motor 185 and has a stator 211 and a rotor 212. Moreover, drive motor 180 is mounted in housing 105 via a drive shaft 215.

Drive shaft 215 is mounted in housing 105 via a bearing element 250 so as to face second axial end 102. For illustration purposes, fan 130 is disposed in the region of first axial end 101 of drive unit 127 on drive shaft 215. In addition, at least one motor component 280 is allocated to drive motor 180, which is situated facing second axial end 102. At least sections of gear unit 125 are preferably situated on drive shaft 215, gear unit 125 being situated on an end of drive shaft 215 facing second axial end 102.

A drive-side gearbox flange 230 is preferably allocated to gear unit 125. Gearbox flange 230 is designed to seal at least sections of gear unit 125. Gearbox flange 230 is supported at its end facing first axial end 101 via a bearing element 292 on drive shaft 215. In addition, the end of drive shaft 215 facing second axial end 102 is connected to an output shaft 299 via gear unit 125. An end of output shaft 299 facing first axial end 101 is mounted via a bearing element 290 in gearbox flange 230. Output shaft 299 is developed to drive tool holder 140.

Gearing 120 allocated to gear unit 125 is preferably developed as a planetary gear. A ring gear 294 allocated to the planetary gear is situated in gearbox flange 230. Gearbox flange 230 has an inner mount 248 for this purpose.

According to one example embodiment of the present invention, drive-side gearbox flange 230 has an accommodation region 236 at its end face 241 facing the stator. Accommodation region 236 is preferably developed to accommodate at least sections of stator 211. In particular, accommodation region 236 is developed to accommodate at least sections of at least one motor component 280 allocated to stator 211.

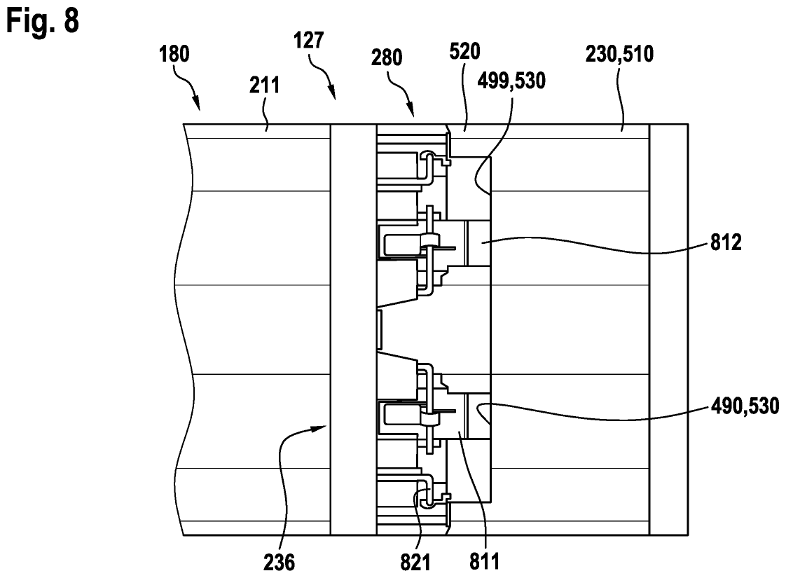

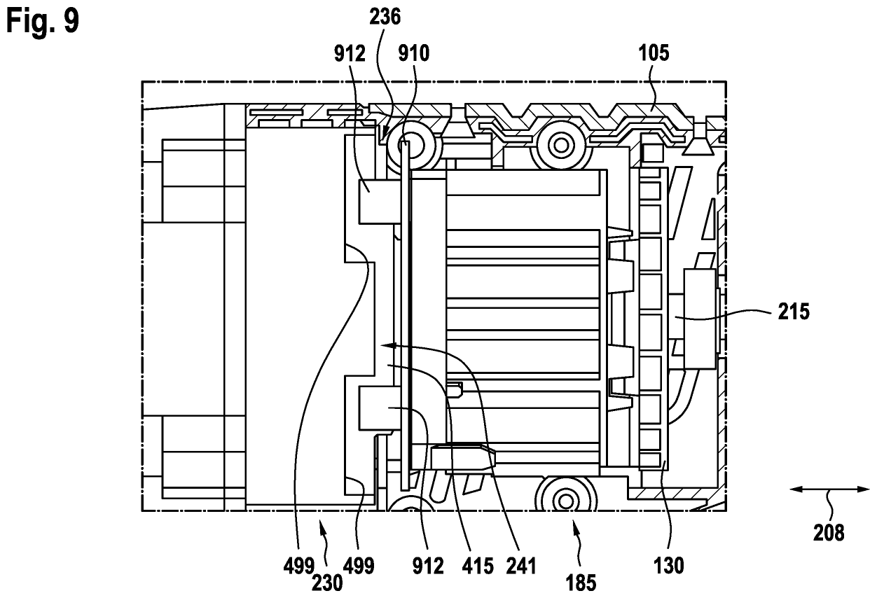

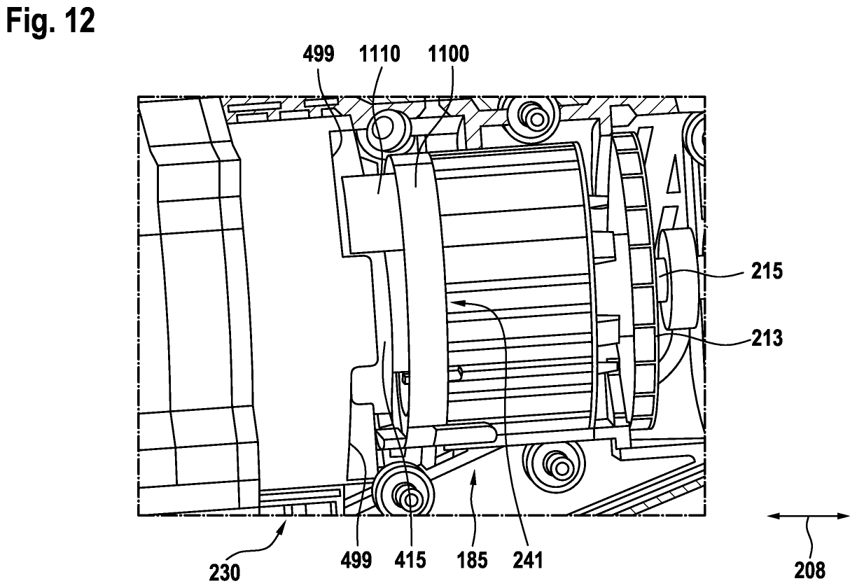

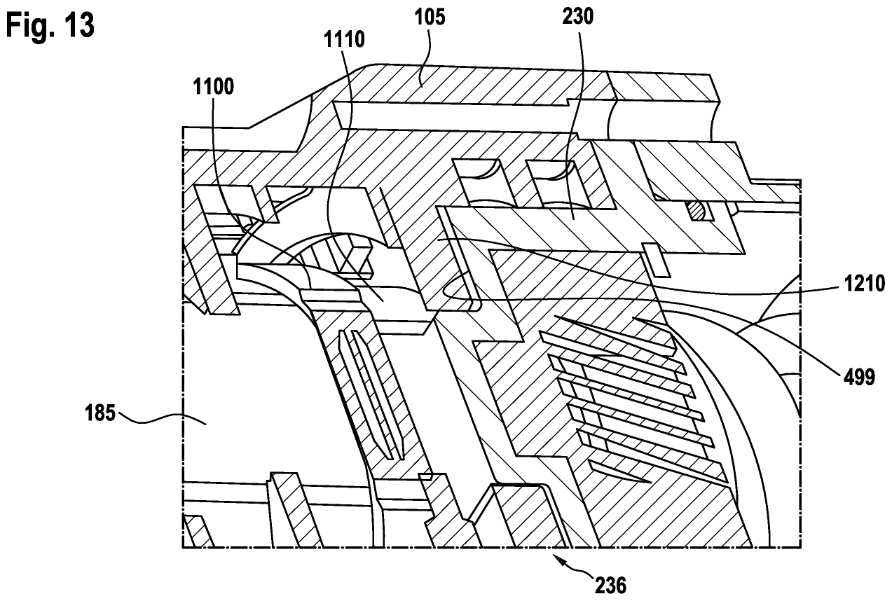

The at least one motor component 280 is situated between drive motor 180 and gear unit 125, in particular a gearbox flange 230. The at least one motor component 280 is allocated to drive motor 180 and in particular is fastened to drive motor 180 on the output side. The at least one motor component 280 is developed as a mechanical motor component, e.g., as an anti-rotation web (1110 in FIG. 12 and FIG. 13) of stator 211 of drive motor 180, as an electromechanical motor component such as a motor terminal (811, 812 in FIG. 8), and/or as an electrical motor component, e.g., an electronics circuit board, i.e., a circuit board fitted with electronic components (910 in FIG. 9).

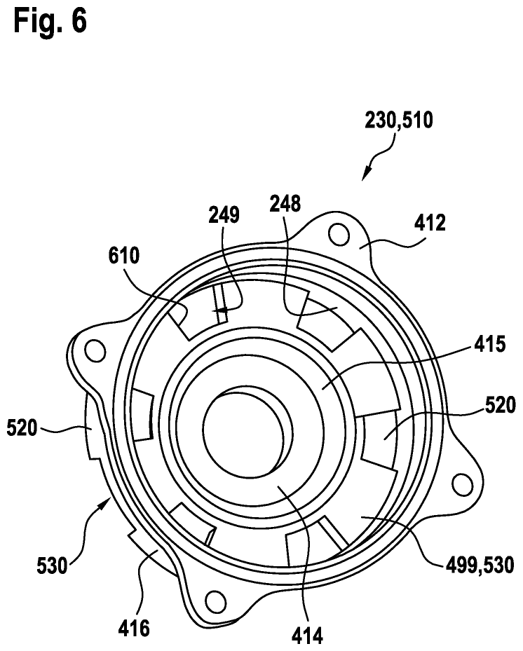

The inner mount 248 of gearbox flange 230 is developed for the positioning of gear unit 125. An output-side end face 249 of accommodation region 236 of gearbox flange 230 preferably has receptacles (610 in FIG. 6), ring gear 294 of gear unit 125 being at least partially situated in the receptacles (610 in FIG. 6) in order to form an anti-rotation lock.

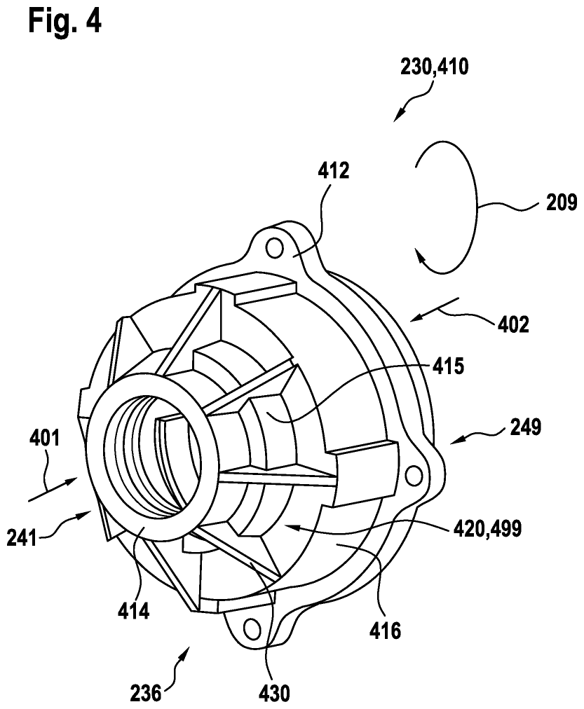

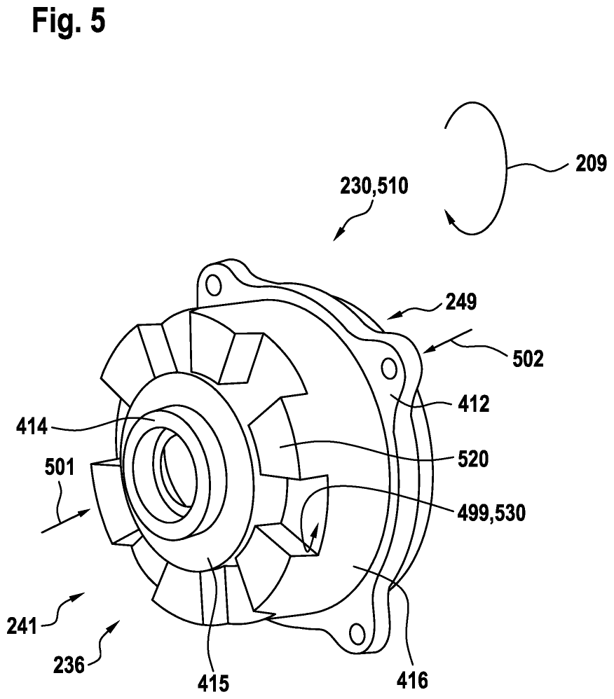

According to one example embodiment, accommodation region 236 has at least one accommodation element (499 in FIG. 4 and FIG. 5) in circumferential direction 209 of drive-side gearbox flange 230 for the accommodation of at least one motor component 280. The at least one accommodation element (499 in FIG. 4 and FIG. 5) is developed in such a way that the at least one motor component 280 projects beyond bearing elements 290, 292 for supporting drive-side gearbox flange 230 in longitudinal direction 208 of drive unit 127.

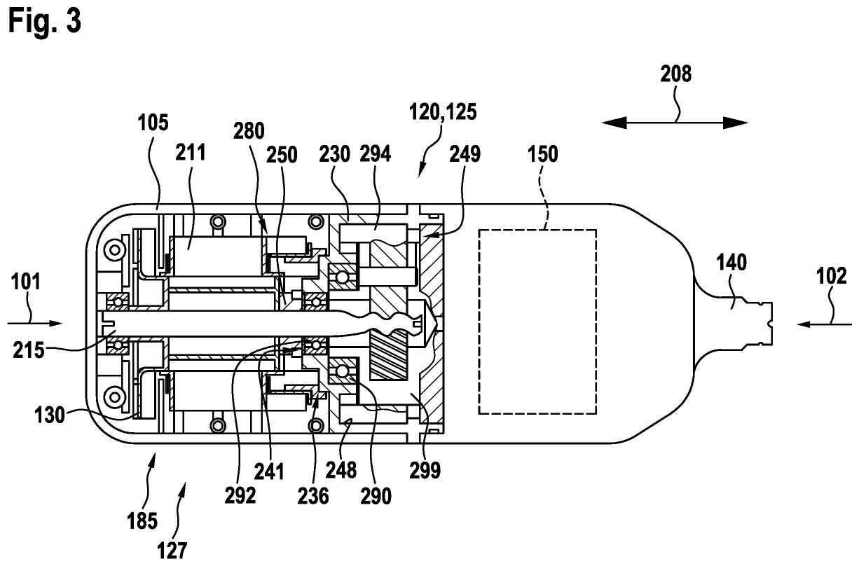

FIG. 3 shows drive unit 127 of FIG. 1 and FIG. 2. FIG. 3 illustrates an alternative gearbox flange 230 or 510 in FIG. 5. Gearbox flange 230 or 510 is described in greater detail in FIG. 5.

FIG. 4 shows gearbox flange 230 of FIG. 2, which is developed according to a further embodiment and is therefore denoted as gearbox flange 410 in the following text. Gearbox flange 410 has a first axial end 401, which is situated so as to face first axial end 101 of drive unit 127. In addition, gearbox flange 410 has a second axial end 402, which is situated opposite first axial end 401. Gearbox flange 410 has at its second axial end 402 at least one, or for illustration purposes, three, and preferably four holding flanges 412 for the positioning in housing 105.

At its first axial end 401, gearbox flange 410 has a first bearing region 414 for the positioning of first bearing element 292. Set apart from first bearing region 414 is a second bearing region 415 for the positioning of second bearing element 290.

First bearing region 414 preferably has a first outer diameter, and second bearing region 415 has a second outer diameter. The second outer diameter is preferably greater than the first outer diameter.

For illustration purposes, first bearing region 414 widens in the direction of second axial end 402 of gearbox flange 410 into second bearing region 415. In addition, second bearing region 415 widens in the direction of second axial end 402 of gearbox flange 410 into an accommodation region 416. Accommodation region 416 has a greater outer diameter than second bearing region 415.

In addition, gearbox flange 410 has at least one, and for illustration purposes, eight longitudinal webs 430. Longitudinal webs 430 connect an outer diameter or outer circumference of accommodation region 416 to bearing region 415 and to bearing region 414. The illustrated eight longitudinal webs 430 have a triangular base body by way of example.

However, it is pointed out that the described number of longitudinal webs is of an exemplary nature and should be not considered a restriction of the present invention. For example, gearbox flange 410 may have any number of longitudinal webs 430. Moreover, different longitudinal webs 430 may also be developed, which means, for instance, that a longitudinal web connects accommodation region 416 and second bearing region 415 to each other, and a further longitudinal web connects second bearing region 415 to first bearing region 414. The different longitudinal webs may have various forms.

According to one example embodiment of the present invention, longitudinal webs 430 of the at one accommodation region 236 form allocated accommodation elements 499. For instance, the at least one accommodation element 499 in circumferential direction 209 of gearbox flange 410 or gearbox flange 230 of FIG. 1 and FIG. 2 is developed to accommodate at least one motor component 280, or 811, 812 in FIG. 8. According to the embodiment shown in FIG. 4, accommodation element 499 is developed as a receptacle 420. However, accommodation element 499 may also be developed as a recess (530 in FIG. 5). Recesses 420 preferably form an accommodation geometry. Accommodation elements 499 are preferably developed so that the at least one motor component 280, or 811, 812 in FIG. 8, projects beyond bearing elements 290, 292 for supporting gearbox flange 410, or gearbox flange 230 of FIG. 1 and FIG. 2, in longitudinal direction 208. This makes it possible to achieve a nested arrangement of the stator with the gearbox flange, which allows for a compact positioning. It also makes it possible to achieve a function concentration.

FIG. 5 shows gearbox flange 230 of FIG. 3, which is developed according to a further embodiment of the present invention and will therefore be denoted as gearbox flange 510 in the following text. Gearbox flange 510 has a first axial end 501, which is disposed so as to face first axial end 101 of drive unit 127. In addition, gearbox flange 510 has a second axial end 502, which lies opposite first axial end 501. Similar to gearbox flange 410 of FIG. 4, gearbox flange 510 has holding flanges 412 as well as accommodation region 416 and first and second bearing region 414 and 415. Accommodation elements 499 of gearbox flange 510 are preferably developed as recesses 530. Recesses 530 are able to be developed with the aid of a milling operation. An accommodation geometry 520 is preferably developed in the process. However, it is pointed out that accommodation geometry 520 may also be formed by receptacles. Gearbox flange 230 may be developed as an injection-molding part for forming the receptacles, for example.

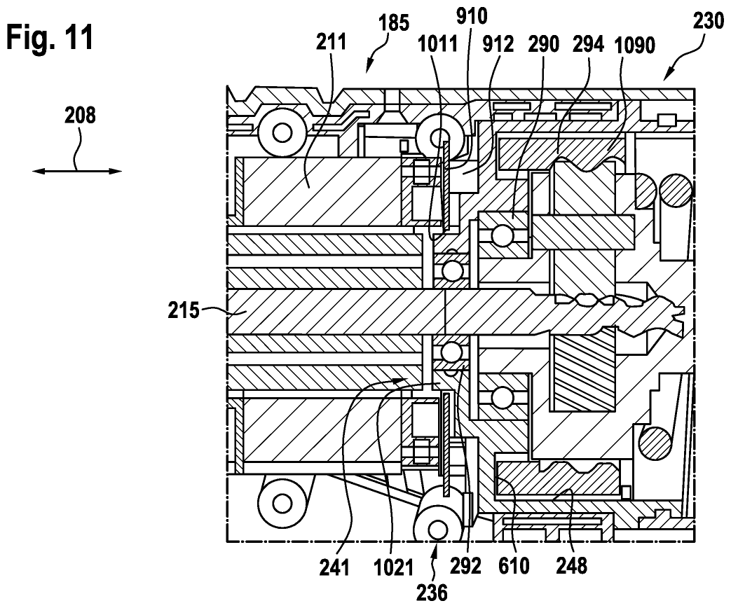

FIG. 6 shows gearbox flange 510 of FIG. 5 in a view from the direction of its second axial end 502. FIG. 6 illustrates accommodation region 416 or inner mount 248 of gearbox flange 230 or 510. As described earlier, inner mount 248 is developed for the positioning of gear unit 125, where an output-side end face 249 of accommodation region 236 of gearbox flange 230 or 510 forms the anti-rotation lock for ring gear 294 of gear unit 125, in particular of gearing 120. Recesses 530 preferably form receptacles 610 on the output-side end face 249 of accommodation region 236. Receptacles 610 are developed for the regional positioning of ring gear 294. Toward this end, ring gear 294 has at least one axial widening web (1090 in FIG. 11) in the axial direction or in longitudinal direction 208 of drive unit 127, which may be positioned in one of receptacles 610. An anti-rotation lock of gear unit 125, preferably of gearing 120, in particular of ring gear 294 of gearing 120 in gearbox flange 510, is produced in the process. Ring gear 294 is preferably positioned in gearbox flange 510 in a torsionally fixed manner, which means that ring gear 294 is fixedly positioned in gearbox flange 510 in circumferential direction 209.

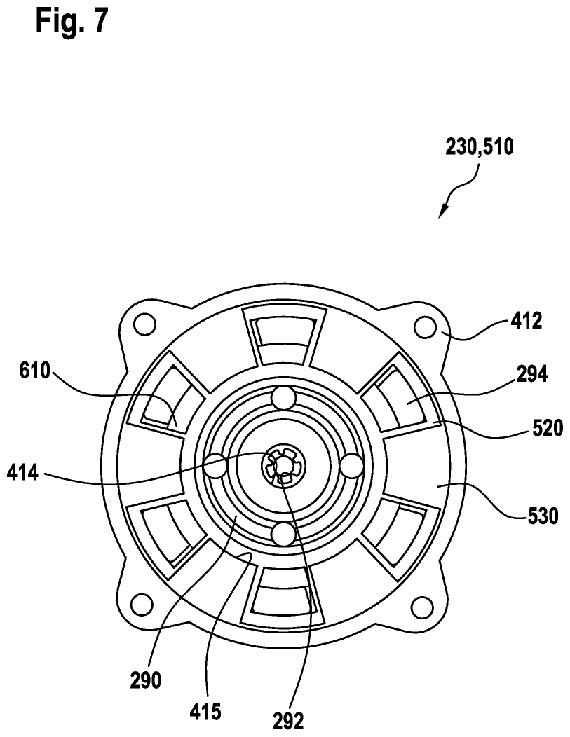

FIG. 7 shows gearbox flange 510 of FIG. 5 and FIG. 6 with ring gear 294 of gear unit 125 as well as first and second bearing elements 290, 292. For illustration purposes, bearing element 292 is preferably situated in first bearing region 414. In addition, bearing element 290 is situated in second bearing region 415. Moreover, ring gear 294 is disposed on end face 249 of accommodation region 236. In particular, ring gear 294 together with the at least one axial expansion web (1090 in FIG. 11) is situated in receptacles 610, the anti-rotation lock being created in the process.

FIG. 8 shows drive unit 127 with drive motor 180 as well as gearbox flange 230 or 510 of FIGS. 5 through 7. FIG. 8 illustrates the placement of the at least one motor component 280 in accommodation region 236 of gearbox flange 230. Here, the at least one motor component 811, 812 allocated to stator 211 is at least regionally disposed in accommodation element 499 of gearbox flange 510 or 230 developed as recess 530. For illustration purposes, the at least one motor component 811, 812 is preferably developed as a motor terminal. However, it is pointed out that the at least one motor component 811, 812 may also be developed as any other part, in particular an electrical part of drive motor 180. For illustration purposes, a motor terminal 811, 812 is situated in accommodation elements 499 developed as recesses 530 in each case.

It is pointed out that at least one motor component 811, 812 is situated in an accommodation element 499. Drive motor 180 preferably has a plurality of motor components 811, 812 or motor terminals, which may be situated in accommodation elements 499. In FIG. 4 and FIGS. 5 through 7, gearbox flange 230 may have a number of accommodation elements 499 that are allocated to motor terminals 811, 812. In addition, drive motor 180 may have any number of motor components 811, 812, and gearbox flange 230 may have a deviating number of accommodation elements 499 in FIG. 4 or in FIGS. 5 through 7. A motor component need not necessarily be placed in every accommodation element 499. In addition, accommodation elements 499 in FIG. 4 and in FIGS. 5 through 7 may also be developed only regionally in circumferential direction 209 of gearbox flange 230, e.g., at a 9 o'clock position to a 3 o'clock position, for instance. According to the embodiment shown in FIG. 8, motor components 811, 812, as described above, are motor terminals, i.e. connection elements that are developed to connect the individual wires 821 or windings of drive motor 180.

According to one variant, gearbox flange 230 and ring gear 294 of gear unit 125 are able to be developed in one piece. According to a further variant, gearbox flange 230 and ring gear 294 of gear unit 125 could not have an integral design, but instead be made up of multiple pieces. Motor components 811, 812 are situated so as to face first axial end 101 of drive unit 127 on stator 211. In particular, motor components 811, 812 are situated so as to face gearbox flange 230.

FIG. 9 shows drive unit 127 of FIGS. 1 to 3 having drive motor 185 as well as gearbox flange 230 of FIGS. 5 through 8. FIG. 9 illustrates a positioning of an alternative motor component 910 in accommodation region 236 of gearbox flange 230. Motor component 910 is preferably a circuit board 910, which is fitted with electronic components 912 and allocated to drive motor 185. Circuit board 910 is preferably situated in longitudinal direction 208 between drive motor 185 and gearbox flange 230. In particular, circuit board 810 is situated coaxially with drive motor 185. Electronic components 912 are preferably developed in longitudinal direction 208. For illustration purposes, electronic components 912 are at least regionally situated in accommodation element 499 of gearbox flange 230. Circuit board 910 is preferably fastened to drive motor 185. With the aid of a screwed connection, circuit board 910 is preferably fastened to drive motor 185. Circuit board 910 preferably forms a motor electronics for controlling and/or regulating drive unit 127, in particular drive motor 185.

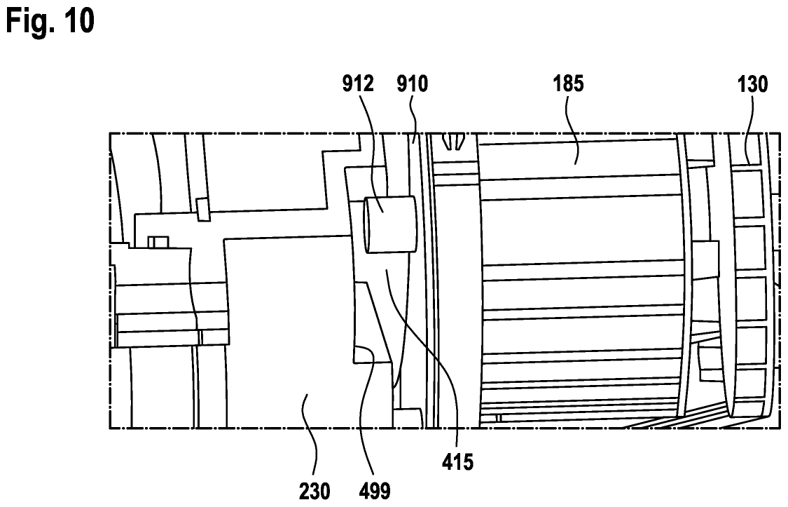

FIG. 10 shows drive motor 185 as well as gearbox flange 230 with circuit board 910 of FIG. 9. FIG. 10 illustrates the at least partial positioning of electronic components 912 of circuit board 910 in accommodation element 499 of gearbox flange 230.

FIG. 11 shows drive motor 185, gearbox flange 230 as well as circuit board 910 of FIG. 9 and FIG. 10. Circuit board 910 has an annular base body, which is preferably situated at an outer circumference of accommodation region 236 and has an inner circumference 1011. Accommodation region 236 includes a bearing section 1021 in which bearing element 292 is situated. Bearing section 1021 is preferably developed in the shape of a sleeve. Bearing section 1021 is preferably formed in one piece with gearbox flange 230, in particular in the way of an annular collar on gearbox flange 230. Inner circumference 1011 of circuit board 910 or the annular base body is preferably situated at the outer circumference of bearing section 1021. This may allow for an overlap of gearbox flange 230 with electronic components 912 of circuit board 910. In addition, better support is possible because a projection of drive shaft 215 of FIG. 2 beyond bearing element 292 is able to be reduced.

In addition, FIG. 11 illustrates the anti-rotation lock of ring gear 294 in gearbox flange 230. Sections of ring gear 294 are situated in receptacles 610 of gearbox flange 230. Toward this end, ring gear 294 has at least one expansion web 1090, which is situated in receptacles 610 in FIG. 11, in the axial direction or in longitudinal direction 208 of drive unit 127. This creates the anti-rotation lock of ring gear 294 of gearing 120 in gearbox flange 230. Ring gear 294 is preferably situated in gearbox flange 230 in a torsionally fixed manner, or in other words, ring gear 294 is fixedly situated in gearbox flange 230 in circumferential direction 209.

FIG. 12 shows drive unit 127 of FIGS. 1 through 3 together with drive motor 185 as well gearbox flange 230 of FIGS. 5 through 11. An end cap 1100, which is situated facing gearbox flange 230, is allocated to drive motor 185. FIG. 12 illustrates a placement of an alternative motor component 1110 in accommodation region 236 of gearbox flange 230. Motor component 1110 according to a further embodiment is at least one anti-rotation web allocated to drive motor 185. For illustration purposes, anti-rotation web 1110 developed in longitudinal direction 208 is allocated to end cap 1100. The at least one anti-rotation web 1110 is at least regionally situated in accommodation element 499 of gearbox flange 230. End cap 1100 is preferably fastened to drive motor 185, in particular to stator 211. Anti-rotation web 1110 is preferably developed in one piece together with end cap 1100. Anti-rotation web 1110 is developed to firmly position stator 211 of drive motor 185 in circumferential direction 209.

FIG. 13 shows drive motor 185, gearbox flange 230 as well as end cap 1100 of FIG. 12. FIG. 13 illustrates an exemplary web 1210 allocated to housing 105 for the positioning of gearbox flange 230 in housing 105. In addition, FIG. 13 shows anti-rotation web 1110 situated in accommodation element (499).

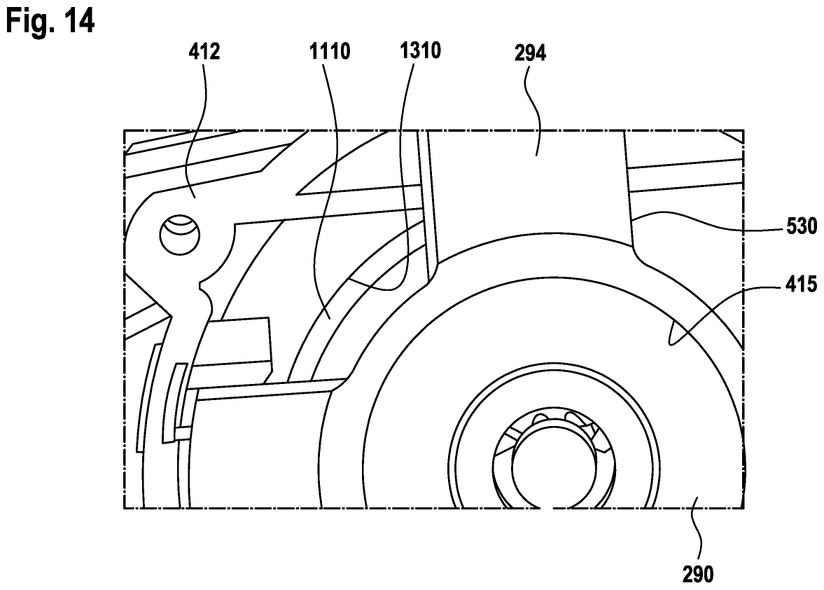

FIG. 14 shows gearbox flange 230 of FIG. 13 viewed from the direction of end face 249 of FIG. 5 or from the direction of the output side, together with ring gear 294 of FIG. 2 of gear unit 125 as well as bearing element 290 of FIG. 2. Bearing element 290 is preferably situated in second bearing region 415. In addition, ring gear 294 is situated on end face 249 of accommodation region 236. According to another embodiment, gearbox flange 230 has at least one recess 1310 in order to allow anti-rotation web 1110 to penetrate end cap 1100. This makes it possible to enlarge an overlap of anti-rotation web 1110 and gearbox flange 230. In addition, spatial nesting of the anti-rotation lock of ring gear 294 and anti-rotation web 1110 is achieved in this way. Recess 1310 is preferably developed in circumferential direction 209 between two receptacles 610 of gearbox flange 230. As a result, an axial length of drive unit 127 is able to be reduced due to the nesting.

What is claimed is:

1. A handheld machine tool, comprising:
a tool holder;
a housing in which are situated at least one gear unit and an electronically commutated drive motor including a stator and a rotor for driving an insertion tool configured to be placed in the tool holder; and
a drive-side gearbox flange allocated to the gear unit, which at least regionally seals the gear unit, wherein the drive-side gearbox flange has, on an end face facing the stator, an accommodation region for the at least regional accommodation of at least one motor component allocated to the stator.

2. The handheld machine tool as recited in claim 1, wherein the accommodation region has at least one accommodation element in a circumferential direction of the drive-side gearbox flange for the accommodation of the at least one motor component.

3. The handheld machine tool as recited in claim 2, wherein webs are provided, which are developed to form the at least one accommodation element allocated to the accommodation region.

4. The handheld machine tool as recited in claim 2, wherein the at least one accommodation element allocated to the accommodation region is a recess.

5. The handheld machine tool as recited in claim 2, wherein the at least one accommodation element is configured to at least regionally accommodate the at least one motor component allocated to the stator.

6. The handheld machine tool as recited in claim 5, wherein in at least one motor component includes motor terminals.

7. The handheld machine tool as recited in claim 5, wherein the at least one accommodation element is configured in such a way that the at least one motor component projects beyond bearing elements for supporting the drive-side gearbox flange in a longitudinal direction of the drive motor.

8. The handheld machine tool as recited in claim 1, wherein the drive-side gearbox flange has on a first axial end a first bearing region for positioning of a first bearing element and a second bearing region, which is set apart from the first bearing region, for positioning of a second bearing element.

9. The handheld machine tool as recited in claim 8, wherein the first bearing region has a first outer diameter and the second bearing region has a second outer diameter, which is greater than the first outer diameter.

10. The handheld machine tool as recited in claim 1, wherein the gearbox flange has an inner mount for positioning of the gear unit, and an output-side end face of the accommodation region of the gearbox flange has receptacles, and a ring gear of the gear unit is regionally situated in the receptacles to form an anti-rotation lock.

11. The handheld machine tool as recited in claim 1, wherein the handheld machine tool is a rotary hammer drill having a percussive tool, the percussive tool being allocated to the gear unit.

12. The handheld machine tool as recited in claim 1, wherein the at least one motor component is a circuit board, which is fitted with electronic components and allocated to the drive motor.

13. The handheld machine tool as recited in claim 1, wherein the at least one motor component is an anti-rotation web, which is allocated to the drive motor and configured in a longitudinal direction of the drive motor.

14. The handheld machine tool as recited in claim 13, wherein the gearbox flange has a recess, which is allocated to the at least one anti-rotation web to allow the at least one anti-rotation web to penetrate the gearbox flange.
